(19) United States
(12) Patent Application Publication
(10) Pub. No.: US 2025/0109047 A1
(43) Pub. Date: Apr. 3, 2025

(54) CAPTURING FENTANYL USING BIOSYNTHETIC MELANIN

(71) Applicant: The Government of the United States of America, as represented by the Secretary of the Navy, Arlington, VA (US)

(72) Inventors: Zheng Wang, Burke, VA (US); Dagmar Leary, Alexandria, VA (US); Jaimee Compton, Washington, DC (US); Christopher Katilie, West Springfield, VA (US); Gregory Ellis, Rockville, MD (US); Gary Vora, North Potomac, MD (US)

(73) Assignee: The Government of the United States of America, as represented by the Secretary of the Navy, Arlington, VA (US)

(21) Appl. No.: 18/902,293

(22) Filed: Sep. 30, 2024

Related U.S. Application Data
(60) Provisional application No. 63/542,192, filed on Oct. 3, 2023.

(51) Int. Cl. C02F 1/28; C02F 101/38

(52) U.S. Cl. CPC C02F 1/286; C02F 2101/38

(57) ABSTRACT

Biosynthetic melanin can capture fentanyl from aqueous environments. The captured fentanyl can be released by introducing the fentanyl-bound melanin to an acidic environment. In this way, fentanyl can capture melanin for subsequent detection/analysis, in addition to operating to remove fentanyl for decontamination.

### REFERENCE TO RELATED APPLICATIONS

This application claims the benefit of U.S. Provisional Application No. 63/542,192, filed on Oct. 3, 2023. The provisional application and all other publications and patent documents referred to throughout this nonprovisional application are incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing NC 211363.

### DESCRIPTION OF THE RELATED ART

Melanins represent a promising class of protective biopolymers that are ubiquitously present in nature and confer a survival advantage to organisms in extreme environments. Utility of physiochemical properties has allowed melanins to be used in broad applications including protective coatings, thermal protection, energy storage devices, bioremediation and biomedical imaging.

A need exists for new uses for melanin.

### SUMMARY OF THE INVENTION

Described herein is the use of melanin to reversibly bind fentanyl, thus capturing it for neutralization or detection.

In one embodiment, a method of binding fentanyl includes contacting an aqueous sample containing fentanyl with melanin under conditions allowing the fentanyl to bind to the melanin; and allowing the fentanyl to bind to the melanin. Optionally, the fentanyl can be de-bound using acid. Example types of melanin include, but are not limited to eumelanin, pheomelanin, allomelanin, and their derivatives.

### BRIEF DESCRIPTION OF DRAWINGS

A more complete appreciation will be readily obtained by reference to the following Description of the Example Embodiments and the accompanying drawings.

FIGS. 1A and 1B show melanin stocks (5 mg/mL) from melanin granules and ghosts, respectively. (1) Vnat Tyrosine; (2) Vnat Dopamine, (3) Vnat Tyrosine+Cysteine, (4) Vnat Dopamine+Cysteine, (5) Fungal Elc.

FIGS. 2A and 2B depict melanin granule fentanyl binding/de-binding result from six replicates of each type of sample. FIG. 2A shows the percentage of non-bound fentanyl remaining the supernatant; FIG. 2B shows the percentage of fentanyl bound by melanin.

FIGS. 3A and 3B depict melanin ghost fentanyl binding/de-binding results from six replicates of each type of sample. FIG. 3A shows percentage of non-bound fentanyl remaining the supernatant; FIG. 3B shows the percentage of fentanyl bound by melanin.

FIG. 4 is a photograph to show morphologies of melanin dried with different methods.

FIG. 5 shows fentanyl binding efficiency with different types of melanin. T1: 30 min, T2: 60 min, 20 μL: 0.1 mg melanin, 40 μL: 0.2 mg melanin.

FIG. 6 shows fentanyl de-binding efficiency with different types of melanin. T1: 30 min, T2: 60 min, 20 μL: 0.1 mg melanin, 40 μL: 0.2 mg melanin.

### DETAILED DESCRIPTION

### Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

### Overview

As described herein, biosynthetic melanin is used for capturing fentanyl from aqueous environment. The fentanyl can optionally be released from the melanin in an acidic environment, for example in applications for involving detection of fentanyl associated with an individual, group, or environment.

Melanin can be produced by any suitable method including production in bacteria, fungi, or in vitro production. For example, melanin can be produced in the microorganism Vibrio natriegens as described in U.S. patent application Ser. No. 18/229,933 filed on Aug. 3, 2023. Modifications to the molecular or morphological structure of the melanin (granules or melanin ghosts, for example) may provide opportunities for tailoring performance characteristics or selectivity for the target. Production of melanin comprised of different monomer subunits may also offer methods for tuning the function of the product. Melanin containing bacterial or fungal species, melanin in growth media (or supernatant), melanin ghosts, and other purified melanin products may all be suitable to this application.

Fentanyl is a synthetic opioid that is 50-100 times stronger than morphine and is generally used for pain treatment particularly of cancer patients. However, due to its powerful opioid properties and low cost of manufacturing, fentanyl has been diverted for drug abuse, illicit trafficking and increasing production, which has potential to lead to contamination in the environment and presents risks to public population. Therefore, the technology of sampling, identifying and remediating fentanyl from suspected locations has been highly sought after. In this study, by taking advantage of synthetic biology and mass spectrometry, we demonstrate that the biosynthetic melanin is able to effectively capture and release fentanyl from aqueous solution, which represents a novel method of detecting and cleaning fentanyl from environments.

### Examples

A process for production of melanin using the bacterium Vibrio natriegens expressing a tyrosinase gene was described in Wang et al. (ref. 3) and further production improvement was described in U.S. patent application Ser. No. 18/229,933 filed on Aug. 3, 2023. Both of these documents are incorporated herein by reference for the purposes of teaching the production of melanin in Vibrio.

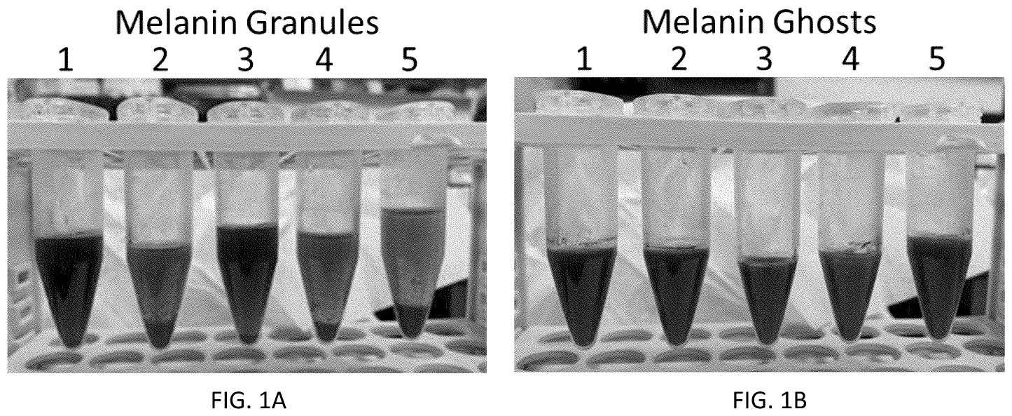

The small scale of melanin production in up to 500 mL V. natriegens (Vnat) bacterial culture was performed and melanin was purified with base/acid cycling method and was dried with a speed vacuum. Tyrosine and Dopamine melanin was synthesized by adding precursor tyrosine and dopamine in the bacterial culture, respectively. Pheomelanin was synthesized by adding precursors tyrosine or dopamine and cysteine at 1:2, 1:1 and 2:1 ratio into the bacterial culture, respectively. (FIGS. 1A and 1B). Bacterial melanin ghosts were made from the melanized V. natriegens cells as described in Wang et al. (refs. 2,3). Fungal DHN-melanin ghosts were made from the black yeast Exophiala laccani-corni (Elc) as described in ref. 7. (FIG. 1B). The large scale of melanin manufacturing was conducted in 1000 L bioreactor at DEVCOM Chemical Biological Center (CBC) and in 100 L bioreactor at Technology Holding LLC (THL), respectively. Melanin produced from DEVCOM CBC was purified from bacterial culture with Tangential Flow Filtration (TFF) technology and was dried with lyophilization or spray-dry technique. Melanin produced from THL was purified from bacterial culture with base/acid cycling method and was dried in an oven at 60° C.

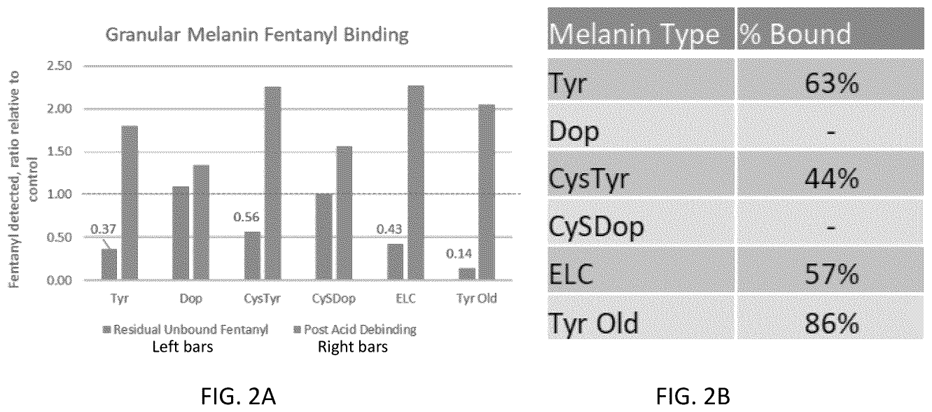

The behavior of the melanin derivatives that adsorb fentanyl was characterized in solution. Five types of melanin granules synthesized from the small scale were selected for the initial fentanyl binding experiment: (1) Vnat tyrosine melanin, (2) Vnat dopamine melanin, (3) Vnat tyrosine-cysteine melanin, (4) Vnat dopamine-cysteine melanin, and (5) Elc DHN-melanin (FIGS. 1A and 1B). In each of 200 μL water solution, 0.1 mg of melanin granules or melanin ghosts was mixed with 50 μM fentanyl and incubated with shaking at room temperature for 60 min. An aliquot of sample (50 μL) was removed and centrifuged. 30 μL of supernatant containing non-bound fentanyl was collected and placed into a vial with the internal standard (100 μL of 1 μM d5-fentanyl) and was analyzed with THERMOFISHER Ultimate 3000-Sciex 5500 HPLC-MRM (high pressure liquid chromatography multiple-reaction monitoring) system. FIG. 2A (blue bars) reveals that two batches of tyrosine based melanin had the highest binding efficiency and captured 63% and 84% of fentanyl from the original solution. Elc DHN melanin and tyrosine/cysteine based melanin mildly captured 57% and 44% of fentanyl, respectively. Dopamine based melanin did not bind fentanyl, indicating that the chemical composition of melanin impacted its interaction with fentanyl. Furthermore, to determine whether the captured fentanyl could be released from melanin, in the remaining 20 μL of solution containing the precipitated melanin granules, 30 μL formic acid was added, vortexed and re-centrifuged. Then 30 μL of the supernatant was directly analyzed with HPLC. The normalized de-binding data in FIG. 2A (orange bars) showed that the bound fentanyl was essentially completely released from melanin granules in the binding-positive samples by resuspending in formic acid (>100% recovery efficiency was due to pipetting errors).

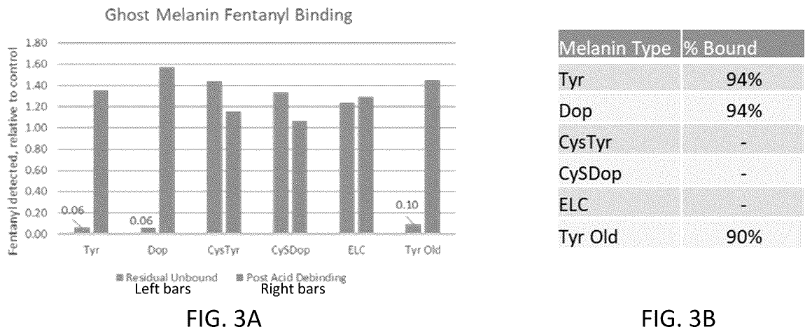

Similarly, melanin ghosts of the same set of melanin derivatives were subjected to the fentanyl binding and de-binding analyses. It was noticed that ghosts of tyrosine-melanin and dopamine-melanin showed higher than 90% binding efficiency (FIGS. 3A and 3B), but those of cysteine related and fungal melanin did not bind fentanyl. The binding discrepancies between granules and ghosts may be resulted from surface size, porosity, pH and preparation procedure in different batches of melanin samples, which requires further investigation. In addition, fentanyl bound to melanin ghosts could be completely removed under the acidic condition (orange bars in FIG. 3A). Regardless, tyrosine-melanin granules in general showed the best binding capability among all of the melanin samples prepared from the small scale, this type of melanin (called eumelanin) was selected for the scale-up studies.

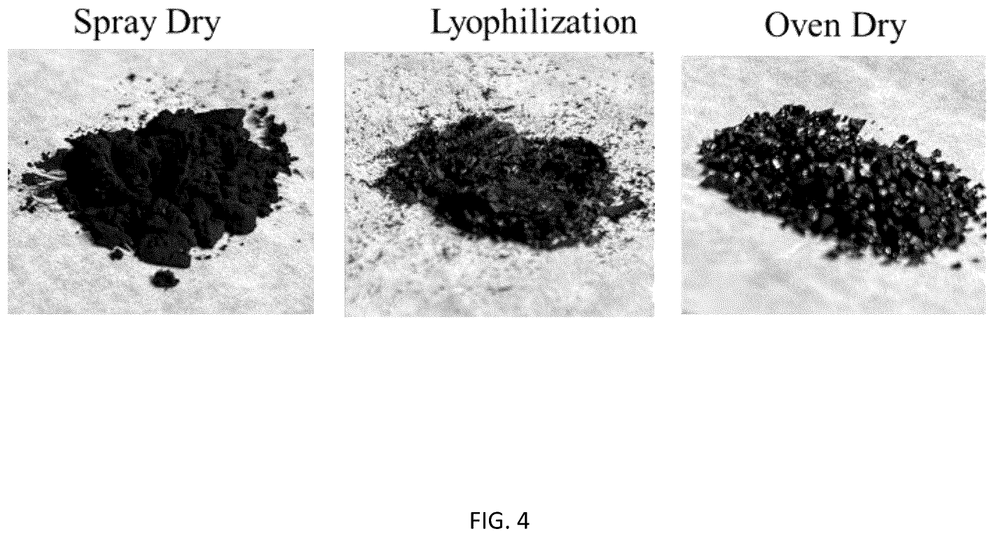

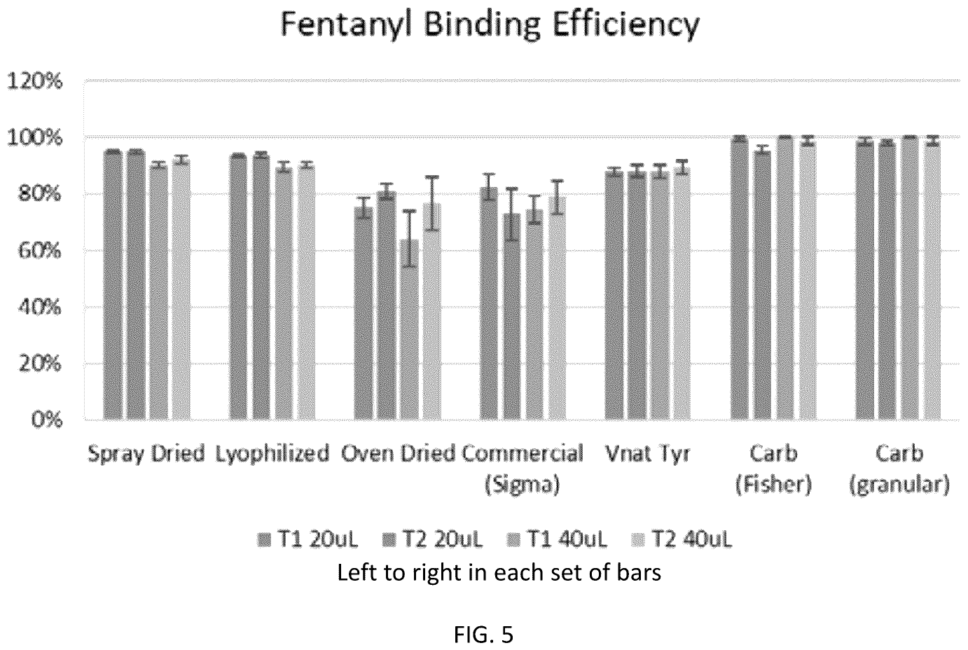

The production of melanin on a larger scales using fermentation technology was undertaken in collaboration with DEVCOM CBC and THL, with the manufacture of more than 3 kg of tyrosine-based melanin (eumelanin) by growing V. natriegens (pJV-Tyr1) cells in 100 L or 1000 L bioreactors. In the downstream processing steps, the extracted melanin was dried with different methods: spray dry, lyophilization and oven dry, resulting in distinct morphologies (FIG. 4). The spray dried melanin showed the finest sizes of powders, the lyophilized melanin was fluffier and the oven dried melanin looked like shining crystals. These three types of eumelanin along with the commercial melanin product (Sigma Aldrich) and the lab-made tyrosine-melanin were applied for binding and de-binding studies as described above. For comparison, two types (powder and granule) of activated carbon, which has been widely used for chemical remediation and filtration, were also included in the experiment. 0.1 mg of melanin (20 μL) was incubated with 5 μM fentanyl for 30 min (T1) or 60 min (T2) before LC-MS/MS analysis. As shown in FIG. 5 and Table 1, in only 30 min, the spray-dried and lyophilized melanin exhibited >94% binding efficiency, which was compatible to activated carbon (99%). The oven-dried melanin, commercial melanin and lab-made melanin that had bigger particle sizes captured fentanyl at the moderate level (75%-88%). It was noted that increasing incubation time to 60 min did not improve the binding efficiency, indicating the robust interaction between melanin and fentanyl. The experiment was then repeated by doubling melanin quantity to 0.2 mg (40 μL) in each reaction, which slightly decreased binding efficiency. These data suggest that the small amount of the manufactured melanin products with smaller particle sizes could quickly adsorb fentanyl from the aqueous environment.

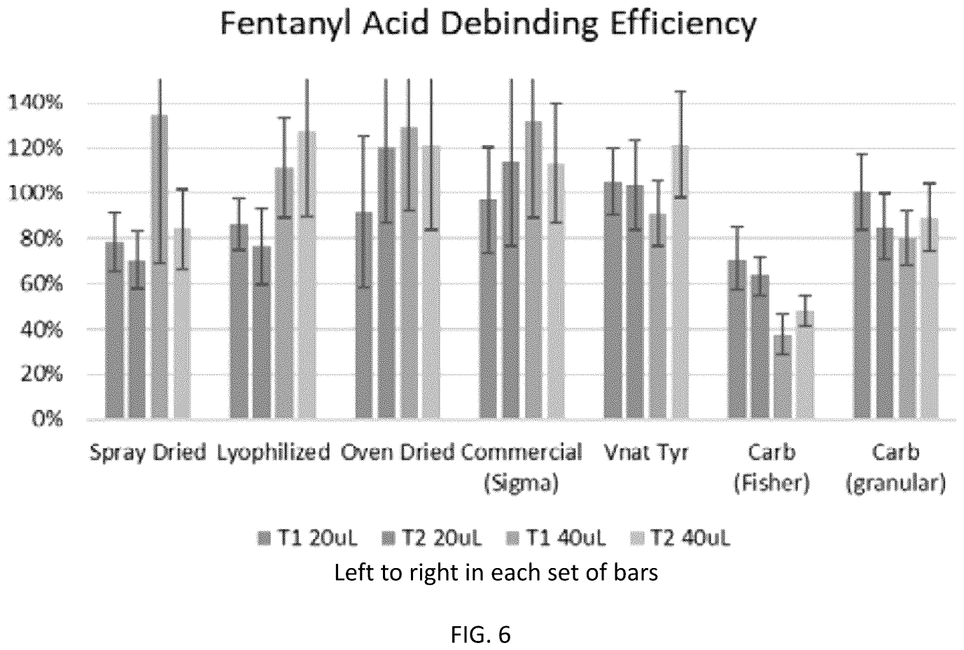

De-binding experiments were performed by adding formic acid into the precipitated melanin. In contrast to the binding result, at 0.1 mg level, the oven-dried, commercial and lab made melanin showed ˜100% de-binding efficiency while the spray-dried and lyophilized melanin had lower efficiency around 80% (FIG. 6 and Table 2). On the other hand, the captured fentanyl was completely released from 0.2 mg of all of the melanin samples in 30 min and 60 min. Thus, although the higher concentration of melanin did not improve the binding efficiency (FIG. 5), it benefited releasing the captured fentanyl at the acid condition. In comparison, activated carbon appeared still retaining a significant amount of fentanyl and particularly, powdered activated carbon showed poorer de-binding efficiency at ˜50%. This results suggest that melanin can be regenerated and represents a renewable biomaterial that has potential to substitute the charcoal-based chemical remediation material.

### Further Embodiments

Other contemplated uses of melanin is for the protection of solid surfaces (coatings) or filtration media as well as adsorbents for decontamination of skin, clothing, solid surfaces, or liquids.

Although the above example used formic acid to release fentanyl, it is expected that release could be achieved by reducing the pH to 4 or less (see ref. 3). For example, citrate-phosphate as well as other organic and/or inorganic acids could be used for this purposes, with or without a buffering agent.

### Advantages

Melanin offers the potential for new detective, protective and decontaminating applications. It could be impregnated into swabs and sensor devices for enrichment and detection of chemical threat agents. Protective applications could include fabrics, air/water filtration, or adsorbents. Decontamination scenarios would likely be as adsorptive materials. The wide variety of molecular and morphological structures offer possibilities for tunable function that have not yet been explored. The described demonstrations could be applied to the generation of swabs, garments, shelters, or pleated filtration materials. A particular advantage of melanin is that it can be manufactured using a bioreactor system that may have a significant cost advantage over synthetic materials suitable to similar applications. Moreover, the biocompatible, regenerative and renewable features may make melanin as an ideal alternative to replace the traditional petroleum or coal based materials in a variety of applications.

State-of-the-art adsorbents and filters utilize carbon materials like activated carbons. These materials are made from carbonaceous source materials (e.g., coconut husk, wood, coal and petroleum) through pyrolyzing at high temperatures up to 1200° C., which can costly, non-renewable, and toxic. As such, there is an industrial demand to use low toxicity biology-based materials for manufacturing to enable cleaner and more renewable processes while providing superior adsorptive and renarrative property. The materials described here may address some of these short-comings. In addition, the flexibility of melanin formats provides the opportunity for combining the approach with classical materials to improve their performance.

### CONCLUDING REMARKS

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

TABLE 1
Summary of results for melanin binding fentanyl

| | Fentanyl bound (%) | | | |
|---|---|---|---|---|
| | 30 min | 30 min | 30 min | 30 min |
| | 0.1 mg | 0.1 mg | 0.2 mg | 0.2 mg |
| Melanin Source | Mel | Mel | Mel | Mel |
| CBC Spray Dry | 95 ± 1% | 95 ± 1% | 90 ± 1% | 92 ± 1% |
| CBC Lyophilized | 94 ± 1% | 94 ± 1% | 89 ± 1% | 90 ± 1% |
| Tech Holding | 75 ± 4% | 81 ± 3% | 64 ± 10% | 77 ± 9% |
| (Oven Dry) | | | | |
| Sigma-Aldrich | 82 ± 5% | 73 ± 9% | 74 ± 5% | 79 ± 6% |
| Vnat Tyrosine | 88 ± 1% | 88 ± 2% | 88 ± 2% | 89 ± 2% |
| Activated Carbon | 99 ± 1% | 96 ± 1% | 99.9 ± 0.1% | 99 ± 1% |
| (Fisher, powder) | | | | |
| Activated Carbon | 99 ± 1% | 98 ± 1% | 99.9 ± 0.1% | 99 ± 1% |
| (granular) | | | | |

TABLE 2
Summary of results for melanin de-binding fentanyl

| | Fentanyl bound (%) | | | |
|---|---|---|---|---|
| | 30 min | 30 min | 30 min | 30 min |
| | 0.1 mg | 0.1 mg | 0.2 mg | 0.2 mg |
| Melanin Source | Mel | Mel | Mel | Mel |
| CBC Spray | 78 ± 13% | 70 ± 13% | 135 ± 66% | 84 ± 18% |
| Dry | | | | |
| CBC | 86 ± 11% | 76 ± 17% | 111 ± 22% | 128 ± 38% |
| Lyophilized | | | | |
| Tech Holding | 92 ± 33% | 120 ± 34% | 129 ± 37% | 121 ± 37% |
| (Oven Dry) | | | | |
| Sigma-Aldrich | 97 ± 23% | 114 ± 37% | 132 ± 43% | 113 ± 27% |
| Vnat Tyrosine | 105 ± 15% | 104 ± 20% | 91 ± 14% | 121 ± 24% |

### REFERENCES

1. d'Ischia, M., Napolitano, A., Pezzella, A., Meredith, P., and Buehler, M. (2020) Melanin Biopolymers: Tailoring Chemical Complexity for Materials Design. Angew Chem Int Ed Engl 59, 11196-11205
2. Wang, Z., Moore, M., Vora, G., and White, B. (2021) Melanin-based chemical protective materials. US Patent US11162212B2
3. Wang, Z., Tschirhart, T., Schultzhaus, Z., Kelly, E. E., Chen, A., Oh, E., Nag, O., Glaser, E. R., Kim, E., Lloyd, P. F., Charles, P. T., Li, W., Leary, D., Compton, J., Phillips, D. A., Dhinojwala, A., Payne, G. F., and Vora, G. J. (2020) Melanin Produced by the Fast-Growing Marine Bacterium Vibrio natriegens through Heterologous Biosynthesis: Characterization and Application. Appl Environ Microbiol 86
4. Xie, W. J., Pakdel, E., Liang, Y. J., Kim, Y. J., Liu, D., Sun, L., and Wang, X. G. (2019) Natural Eumelanin and Its Derivatives as Multifunctional Materials for Bioinspired Applications: A Review. Biomacromolecules 20, 4312-4331
5. Ciesielski, A. L., Wagner, J. R., Alexander-Scott, M., and Snawder, J. (2021) An optimized method for sample collection, extraction, and analysis of fentanyl and fentanyl analogs from a non-porous surface. Talanta 228
6. Compton, W. M. (2017) Research on the use and misuse of fentanyl and other synthetic opioids. National Institute on Drug Abuse, https://archives.nida.nih.gov/about-nida/legislative-activities/testimony-to-congress/2017/research-on-the-use-and-misuse-of-fentanyl-and-other-synthetic-opioids-
7. Romsdahl, J., Schultzhaus, Z., Cuomo, C. A., Dong, H., Abeyratne-Perera, H., Hervey, W. J. t., and Wang, Z. (2021) Phenotypic Characterization and Comparative Genomics of the Melanin-Producing Yeast Exophiala lecanii-corni Reveals a Distinct Stress Tolerance Profile and Reduced Ribosomal Genetic Content. J Fungi (Basel) 7.

What is claimed is:

1. A method of binding fentanyl, the method comprising:
contacting an aqueous sample containing fentanyl with melanin under conditions allowing the fentanyl to bind to the melanin; and
allowing the fentanyl to bind to the melanin to produce fentanyl-bound melanin.

2. The method of claim 1, further comprising introducing the fentanyl-bound melanin to an acidic environment, thereby releasing the fentanyl from the fentanyl-bound melanin.

3. The method of claim 1, wherein the melanin is a tyrosine-based melanin obtained from Vibrio natriegens.

4. The method of claim 3, further comprising introducing the fentanyl-bound melanin to an acidic environment, thereby releasing the fentanyl from the fentanyl-bound melanin.

5. The method of claim 3, wherein the melanin is in a state of having been spray-dried.

6. The method of claim 5, further comprising introducing the fentanyl-bound melanin to an acidic environment, thereby releasing the fentanyl from the fentanyl-bound melanin.

7. The method of claim 1, wherein the melanin is eumelanin, pheomelanin, or allomelanin.

8. The method of claim 7, further comprising introducing the fentanyl-bound melanin to an acidic environment, thereby releasing the fentanyl from the fentanyl-bound melanin.
